(19) United States
(12) Patent Application Publication
(10) Pub. No.: US 2025/0086041 A1
(43) Pub. Date: Mar. 13, 2025

(54) REMOTE CONTROL SYSTEM AND REMOTE CONTROL METHOD

(71) Applicant: Sharp NEC Display Solutions, Ltd., Tokyo (JP)

(72) Inventor: Noboru MISUMI, Tokyo (JP)

(21) Appl. No.: 18/958,738

(22) Filed: Nov. 25, 2024

Related U.S. Application Data
(63) Continuation of application No. PCT/JP2022/023326, filed on Jun. 9, 2022.

(51) Int. Cl. G06F 11/07; G06K 7/14

(52) U.S. Cl. CPC G06F 11/0766; G06K 7/1417

(57) ABSTRACT

A remote control system including: an electronic device that includes an imaging unit; a first terminal device that is used outside a range that is able to be imaged by the electronic device; and a second terminal device that is used in the range that is able to be imaged by the electronic device, the first terminal device including a transmission unit that transmits control data including a control command for the electronic device, the second terminal device including a receiving unit that receives the control data and a second display unit that displays a first image representing the received control data, the electronic device including an execution unit that extracts the control command from the first image and executes processing based on the control command once the first image to be displayed on the second display unit is captured by the imaging unit.

### TECHNICAL FIELD

The present invention relates to a remote control system and a remote control method.

### BACKGROUND ART

In a case in which a failure occurs in a display installed at a customer's place or the like, a contact from the customer may be received, and a person in charge of support may visit the customer and take an action such as searching for a reason for the failure. Examples of the failure include various phenomena including a phenomenon in which a video is not displayed normally, a phenomenon of low brightness, and a phenomenon of no sound.

There is a system that, when a failure occurs in a projector, projects a two-dimensional barcode including an error log and the like from the projector, images the projected two-dimensional barcode with a mobile phone, and transmits the image of the two-dimensional barcode to a support center (Patent Literature 1, for example).

### CITATION LIST

### Patent Literature

[Patent Literature 1]

Japanese Unexamined Patent Application, First Publication No. 2015-130661

### SUMMARY OF INVENTION

### Technical Problem

In a case in which a failure occurs in a display installed in a customer's place and the failure is to be resolved from a remote location, it is necessary for the display and a computer in a support center to be communicably connected via a network.

However, the display may not be connected to a network, and it is not possible to remotely deal with the failure in such a case.

Also, in a case in which a person who is in charge of support visits the customer and deals with the failure, it may be difficult to deal with the failure depending on knowledge and experience of the person who is in charge of support.

The present invention was made in view of such circumstances, and an object thereof is to provide a remote control system and a remote control method capable of remotely dealing with a failure even in an electronic device that cannot perform communication.

### Solution to Problem

An aspect of the present invention is a remote control system including: an electronic device that includes an imaging unit; a first terminal device that is used outside a range that is able to be imaged by the electronic device; and a second terminal device that is used in the range that is able to be imaged by the electronic device, the first terminal device including a transmission unit that transmits control data including a control command for the electronic device, the second terminal device including a receiving unit that receives the control data, and a second display unit that displays a first image representing the received control data, and the electronic device including an execution unit that extracts the control command from the first image and executes processing based on the control command once the first image to be displayed on the second display unit is captured by the imaging unit.

An aspect of the present invention is a remote control method that is performed by a remote control system including an electronic device that includes an imaging unit, a first terminal device that is used outside a range that is able to be imaged by the electronic device, and a second terminal device that is used in the range that is able to be imaged by the electronic device, the method including: by the first terminal device, transmitting control data including a control command for the electronic device; by the second terminal device, receiving the control data; and displaying a first image representing the received control data on a second display unit; and by the electronic device, imaging the first image to be displayed on the second display unit by the imaging unit; and extracting the control command from the imaged first image and executing processing based on the control command.

### Advantageous Effects of Invention

According to the present invention, it is possible to remotely deal with a failure even in an electronic device that cannot perform communication.

### BRIEF DESCRIPTION OF DRAWINGS

FIG. 1 is a schematic configuration diagram illustrating a configuration of a remote control system S according to an embodiment of the invention.

FIG. 2 is a schematic functional block diagram for explaining functions of a terminal device 10.

FIG. 3 is a schematic functional block diagram for explaining functions of a terminal device 20.

FIG. 4 is a schematic functional block diagram for explaining functions of a display device 30.

FIG. 5 is a sequence diagram for explaining operations of the remote control system S.

FIG. 6 is a menu screen before switching to a code display mode.

FIG. 7 is an example of a display screen displayed on the display device 30 after a shift to the code display mode.

FIG. 8 is a conceptual diagram representing how an imaging unit 203 images a two-dimensional barcode displayed on the display device 30.

FIG. 9 is a diagram illustrating an example of a display screen of the terminal device 20 in a case in which a connection request is transmitted to the terminal device 10.

FIG. 10 is a diagram illustrating an example of a display screen displayed on the terminal device 10 that has received the connection request.

FIG. 11 is a diagram illustrating an example illustrating an input screen of the terminal device 10 to receive an input from an engineer.

FIG. 12 is a conceptual diagram representing how the display device 30 images a two-dimensional barcode displayed on the terminal device 20.

FIG. 13 is a diagram illustrating an example of a display screen displayed on the display device 30 by executing Step S303.

FIG. 14 is a diagram illustrating another example of a display screen displayed on the display device 30.

FIG. 15 is a diagram illustrating another example of a display screen displayed on the display device 30.

FIG. 16 is a diagram illustrating another example of a display screen displayed on the display device 30.

FIG. 17 is a schematic functional block diagram illustrating a configuration of a remote control system Sa according to another embodiment.

### DESCRIPTION OF EMBODIMENTS

Hereinafter, a remote control system according to an embodiment of the present invention will be described with reference to the drawings.

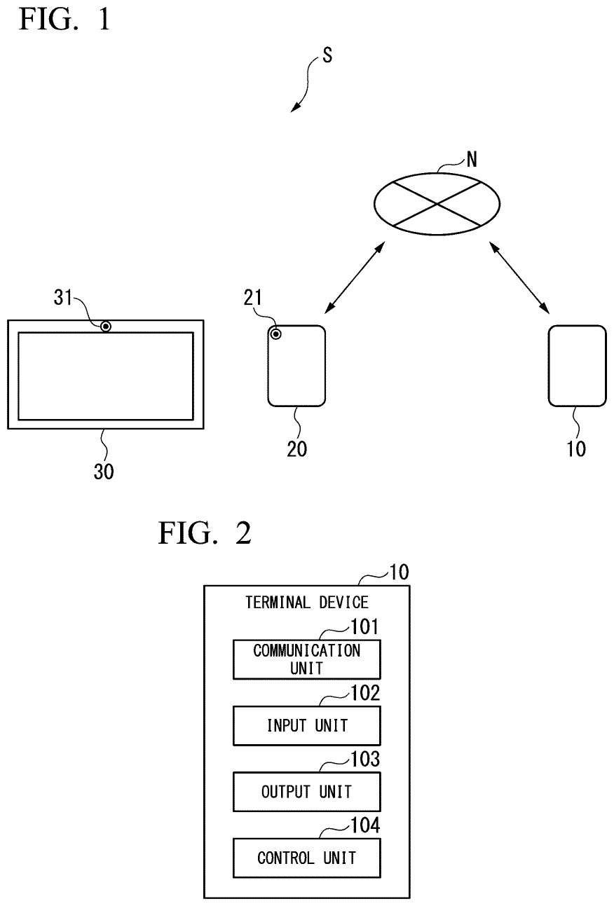

FIG. 1 is a schematic configuration diagram illustrating a configuration of a remote control system S according to an embodiment of the present invention.

The remote control system S includes a terminal device 10, a terminal device 20, a display device 30, and a network N.

The terminal device 10 is used by an engineer who has technical knowledge related to the display device 30. The terminal device 10 is used at a remote location separated from a location where the display device 30 is installed. As the terminal device 10, any one of a smartphone, a tablet, a computer, and the like is used. The terminal device 10 is used as a first terminal device.

The terminal device 10 is used at the remote location separated from the location where the display device 30 is installed.

The terminal device 20 is used by a person who is in charge of support, visits a place where the display device 30 is installed, and deals with a failure occurring in the display device 30. The person who is in charge of support can carry the terminal device and bring it to the place where the display device 30 is installed.

The terminal device 20 includes a camera 21.

As the terminal device 20, any one of a smartphone, a tablet, a computer, and the like is used. The terminal device 20 is used as a second terminal device.

The network N may be the Internet, a public line network, or the like. The terminal device 10 and the terminal device 20 are communicably connected via the network N.

The display device 30 may be a large-sized display to be installed in a public facility, a commercial facility, or the like or may be a display to be connected to a computer.

The display device 30 includes a camera 31.

The display device 30 is not connected to the network N and thus cannot communicate with the terminal device 10.

FIG. 2 is a schematic functional block diagram for explaining functions of the terminal device 10.

The terminal device 10 includes a communication unit 101, an input unit 102, an output unit 103, and a control unit 104.

The terminal device 10 is used outside a range that is able to be imaged by the camera 31 of the display device 30.

The communication unit 101 is communicably connected to the terminal device 20 via the network N and performs communication with the terminal device 20.

The communication unit 101 transmits control data including a control command to the terminal device 20. Also, the communication unit 101 transmits a message to the terminal device 20.

The input unit 102 receives an input of a message representing explanation content related to processing that the display device 30 is caused to perform. The input unit 102 may be any of input devices such as a touch panel, a keyboard, and a mouse.

The output unit 103 outputs an execution status transmitted from the terminal device 20. Also, the output unit 103 outputs response content transmitted from the terminal device 20. The output unit 103 may be a liquid crystal display panel or may be a control unit that controls a drive circuit that drives a liquid crystal display panel.

The control unit 104 controls each component of the terminal device 10.

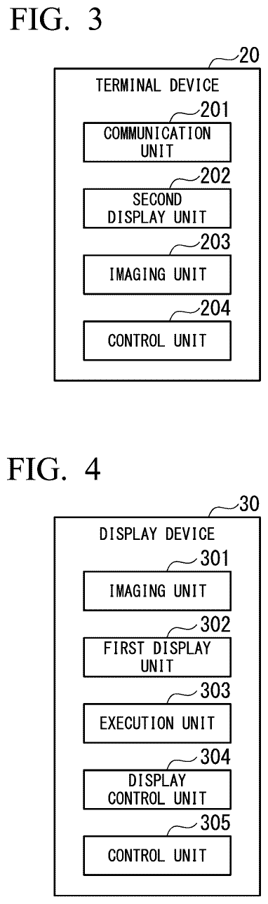

FIG. 3 is a schematic functional block diagram for explaining functions of the terminal device 20.

The terminal device 20 includes a communication unit 201, a second display unit 202, an imaging unit 203, and a control unit 204.

The terminal device 20 is carried to and used in a range that is able to be imaged by the camera 21 of the display device 30.

The communication unit 201 is communicably connected to the terminal device 10 via the network N and performs communication with the terminal device 10.

The communication unit 201 receives control data from the terminal device 10.

The communication unit 201 receives a message from the terminal device 10.

The communication unit 201 transmits an execution status represented by a second image to the first terminal device.

The communication unit 201 transmits response content based on an imaging result to the terminal device 10.

The second display unit 202 displays a first image representing the received control data. The first image may be an image representing an optically readable code and may be, for example, a one-dimensional barcode, a two-dimensional barcode, or a character sequence indicating a code. Also, the first image may be an image in which a character sequence representing the control data is described.

The second display unit 202 displays the first image including the message and the control data.

The second display unit 202 displays a character sequence in accordance with the message.

The imaging unit 203 captures the second image displayed by the electronic device.

The imaging unit 203 images response content displayed on the first display unit.

The control unit 204 controls each component of the terminal device 20.

FIG. 4 is a schematic functional block diagram for explaining functions of the display device 30.

The display device 30 includes an imaging unit 301, a first display unit 302, an execution unit 303, a display control unit 304, and a control unit 305.

The imaging unit 301 images the surroundings of the display device 30. The imaging unit 301 corresponds to the camera 31 in FIG. 1. The imaging unit 301 may be incorporated in the display device 30 or may be attached to the outside of the display device 30 as an optional part for the display device 30.

The first display unit 302 displays various display screens. The first display unit 302 is, for example, a liquid crystal display panel.

The execution unit 303 extracts the control data from the first image and executes processing based on the control data once the first image to be displayed on the second display unit 202 of the terminal device 20 is captured by the imaging unit 301. In a case in which the first image is a one-dimensional barcode or a two-dimensional barcode, the execution unit 303 extracts a code included in the one-dimensional barcode or the two-dimensional barcode by analyzing the one-dimensional barcode or the two-dimensional barcode. In a case in which the first image includes a character sequence including a code, the execution unit 303 extracts the character sequence from the image by performing optical character recognition (OCR) processing on the character sequence and recognizes the character sequence as a code.

The display control unit 304 causes the first display unit 302 to display the second image representing an execution status after the control data is executed using an optically readable code. The processing of analyzing such a first image and extracting information such as control data may be performed by the execution unit 303 or may be performed by the control unit 305.

The display control unit 304 causes the first display unit 302 to display response content in response to a command included in the control data.

The display control unit 304 displays a message included in the first image on the first display unit 302.

The control unit 305 controls each component of the display device 30.

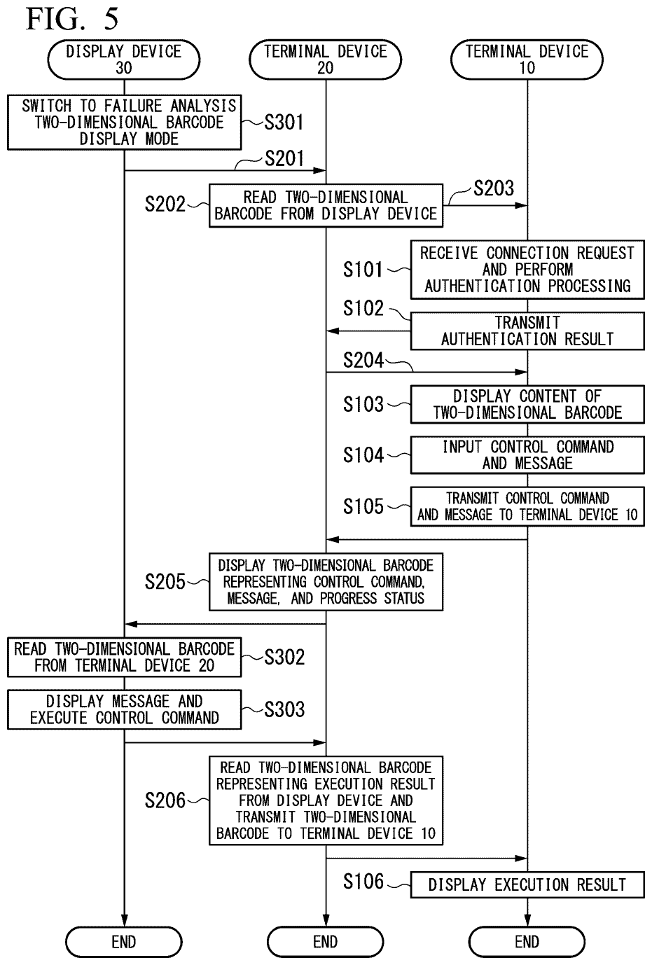

Next, operations of the remote control system S will be described. FIG. 5 is a sequence diagram for explaining operations of the remote control system S.

The person who is in charge of support carries the terminal device 20 and visits the place where the display device 30 is installed on the basis of occurrence of a failure in the display device 30.

The display device 30 performs switching to a code display mode (failure analysis mode) in response to an operation of the person who is in charge of support (Step S301). The code display mode is a mode in which a code indicating an operation state of the display device 30 is displayed on a display screen of the first display unit 302. The code indicating the operation state is a code including at least any one of an error code in accordance with the failure and a code representing various setting values set in the display device 30.

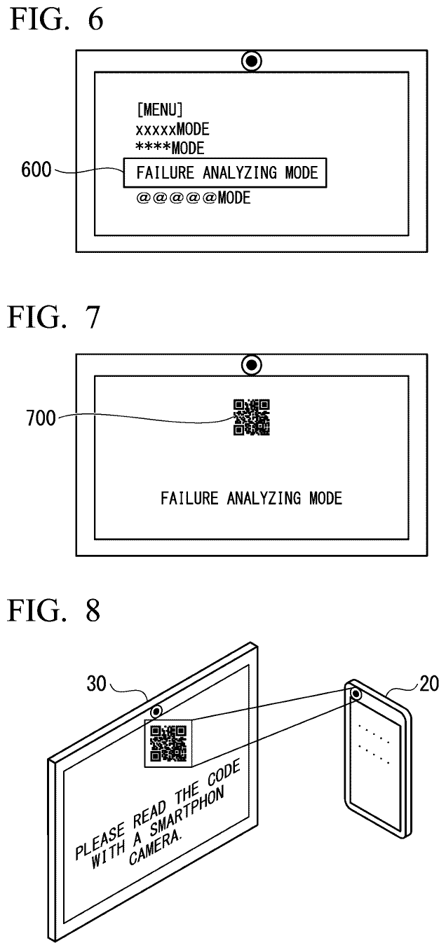

FIG. 6 is a menu screen before the switching to the code display mode. Once an option (reference sign 600) for switching to the code display mode is selected by the person who is in charge of support, the display device 30 shifts to the code display mode.

FIG. 7 is an example of a display screen to be displayed on the display device 30 in the case of the shift to the code display mode. Here, a two-dimensional barcode (reference sign 700) representing a code in accordance with the failure, for example, is displayed. The two-dimensional barcode may represent an error code or may be values representing various current setting values (values such as brightness, luminance, contrast, and volume that are currently set) for the display device 30. Also, a model name and a manufacturing number of the display device 30 may be included in the two-dimensional barcode.

The person who is in charge of support images the two-dimensional barcode displayed on the display device 30 with the imaging unit 203 of the terminal device 20. The imaging unit 203 of the terminal device 20 images the two-dimensional barcode displayed on the display device 30 (Step S202).

FIG. 8 is a conceptual diagram representing how the imaging unit 203 images the two-dimensional barcode displayed on the display device 30.

Once the two-dimensional barcode is imaged, the control unit 204 of the terminal device 20 transmits a connection request to the terminal device 10 (Step S203).

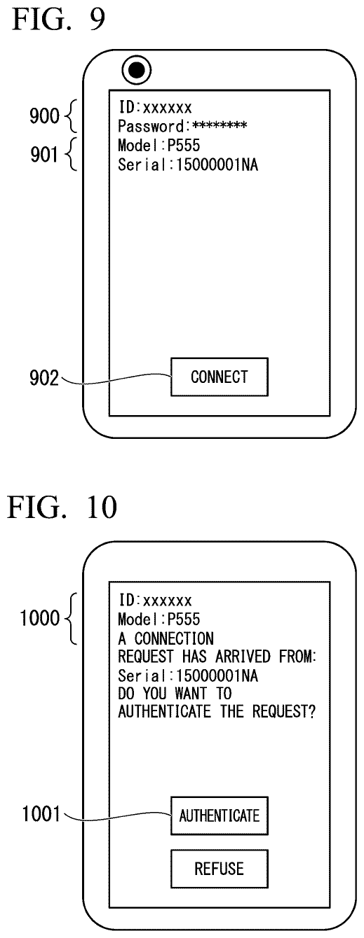

FIG. 9 is a diagram illustrating an example of a display screen of the terminal device 20 in a case in which the connection request is transmitted to the terminal device 10. On the display screen of the terminal device 20, an ID and a password (reference sign 900) of the person who is in charge of support and uses the terminal device 20, a model name and a manufacturing number (reference sign 901) of the display device 30, and a connection button (reference sign 902) for providing an instruction to connect communication to the terminal device 10 are displayed. The ID and the password are on the basis of an account assigned to the person who is in charge of support.

Once the connection request is received, the control unit 104 of the terminal device 10 performs authentication processing (Step S101). If it is determined as a result of the authentication that the connection is to be established in response to the connection request from the terminal device 20, the control unit 104 transmits an authentication result indicating that connection is permitted to the terminal device 20 (Step S102).

FIG. 10 is a diagram illustrating an example of a display screen to be displayed on the terminal device 10 that has received the connection request. On the display screen of the terminal device 10, the ID, and the model name and the manufacturing number of the display device 30 received from the terminal device 20 are displayed (reference sign 1000). The engineer who operates the terminal device 10 presses a button (reference sign 1001) of “authenticated” in a case in which connection is permitted after checking a request source of the connection. Connection is thereby permitted.

Once connection is permitted, the control unit 204 of the terminal device 20 transmits the read two-dimensional barcode to the terminal device 10 through the communication unit 201 (Step S204). The control unit 204 may transmit the two-dimensional barcode as a captured image or may transmit data extracted by interpreting the two-dimensional barcode after conversion into an error code or setting values.

The output unit 103 of the terminal device 10 outputs, to the display screen, content indicated by the two-dimensional barcode such as an error code or setting values received from the terminal device 20 (Step S103).

The engineer of the terminal device 10 inputs an instruction to transmit a control command, on the basis of which the failure seems to be able to be solved, and a message to the terminal device 20 on the basis of the error code, the setting values, or the like displayed on the display screen (Step S104).

FIG. 11 is a diagram illustrating an example illustrating an input screen of the terminal device 10 for receiving an input from the engineer. On the display screen of the terminal device 10, an input section (reference sign 1100) in which a control command to be transmitted to the display device 30 is input, an input section (reference sign 1101) in which a message is input, an input section (reference sign 1102) in which a progress status is input, and a transmission button (reference sign 1103) for providing an instruction to perform transmission are displayed.

The engineer inputs a control command, on the basis of which the failure seems to be able to be forwarded, to the input section for the control command in accordance with the error code or the setting values. The control command may be selected from a pull-down menu deployed from the input section (reference sign 1100). In a case in which the screen of the display device 30 is dark, the engineer can input a control command for increasing the brightness or can input a command to make an inquiry for a display mode. Display modes include a brightness priority mode in which a video signal is displayed with priority placed on brightness, a cinema mode in which brightness and a tone suitable for displaying a movie or the like are set, a color priority mode in which a video signal is displayed with priority placed on tone such that a viewer can feel a comfortable tone, and the like. The engineer can check whether the current display mode is a display mode in accordance with the installation status by making an inquiry for the display mode that is currently being set for the display device 30.

The message represents content to be delivered to from the engineer to the person who is in charge of support. The person who is in charge of support can more deeply understand the current status of dealing with the failure by referring to the message regarding how the engineer is dealing with the failure. Therefore, the engineer can set a message indicating how the engineer is currently dealing with the failure.

The progress status indicates how much the engineer has dealt with the failure to complete it. The person who is in charge of support can check how much the dealing with the failure has progressed by checking the progress status.

The engineer inputs the control command, the message, and the progress status and then presses the transmission button. In this manner, the terminal device 10 transmits the control command, the message, and the progress status to the terminal device 20 (Step S105). The control unit 104 of the terminal device 10 may directly transmit the control command, the message, and the progress status or may convert them into a two-dimensional barcode including them and transmit the two-dimensional barcode to the terminal device 20.

Once the terminal device 20 receives the control command, the message, and the progress status from the terminal device 10, the terminal device 20 displays the two-dimensional barcode including them on the second display unit 202 (Step S205).

Once the two-dimensional barcode is displayed on the terminal device 20, the person who is in charge of support causes the imaging unit 301 of the display device 30 to image the screen on which the two-dimensional barcode is displayed.

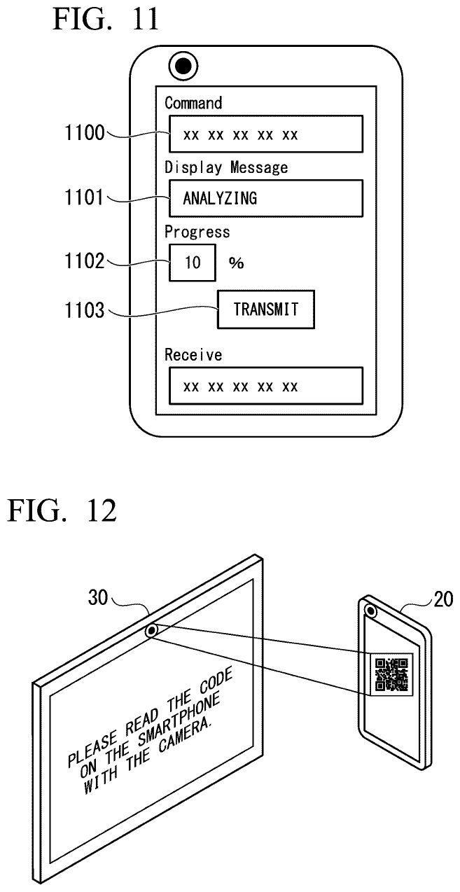

FIG. 12 is a conceptual diagram representing how the display device 30 images the two-dimensional barcode displayed on the terminal device 20.

Once the two-dimensional barcode is imaged by the imaging unit 301, the control unit 305 of the display device 30 reads the two-dimensional barcode (Step S302) and analyzes the read two-dimensional barcode. The control unit 305 of the display device 30 extracts the control command, the message, and the progress status from the two-dimensional barcode by analyzing the two-dimensional barcode and executes the control command on the basis of the extraction result, the display control unit 304 displays the message and the progress status on the first display unit 302. The control unit 305 generates a two-dimensional barcode representing a result of executing the control command, and the display control unit 304 displays the generated two-dimensional barcode on the first display unit 302 (Step S303).

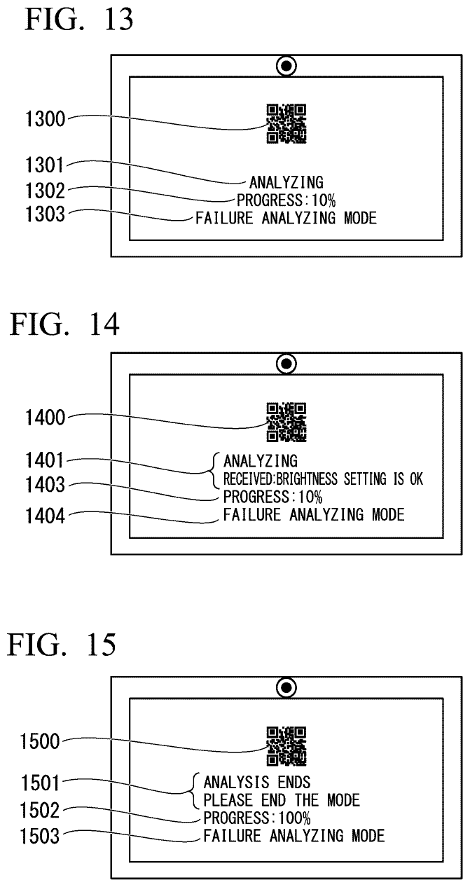

FIG. 13 is a diagram illustrating an example of a display screen displayed on the display device 30 by executing Step S303.

On the display device 30, a two-dimensional barcode (reference sign 1300) indicating the result of executing the control command, a message (reference sign 1301), a progress status (reference sign 1302), and a currently executed mode (reference sign 1303) are displayed. The person who is in charge of support can check the message (reference sign 1301), the progress status (reference sign 1302), and the currently executed mode (reference sign 1303) on the display screen of the display device 30.

Here, the message is “analyzing”, which indicates a stage in which the engineer is analyzing a reason of the failure. Also, the progress status is “progress: 10%”, which is displayed such that the stage where the dealing with the failure has just been started can be recognized. Also, the fact that the currently executed mode is a “failure analyzing mode” is displayed.

FIG. 14 is a diagram illustrating another example of a display screen displayed on the display device 30 by executing Step S303.

On the display device 30, a two-dimensional barcode (reference sign 1400) indicating a result of executing the control command, a message (reference sign 1401), a progress status (reference sign 1302), and a currently executed mode (reference sign 1303) are displayed. The person who is in charge of support can check the message (reference sign 1301), the progress status (reference sign 1302), and the currently executed mode (reference sign 1303) on the display screen of the display device 30.

Here, the message includes “analyzing” and “received: brightness setting is ok”, which indicate the stage in which the engineer is analyzing a reason of the failure and that setting has been able to be completed normally in the result of executing the control command for setting brightness. Also, the progress status is “progress: 10%”, which is displayed such that the stage where the dealing with the failure has just been started can be recognized. It is possible to recognize from the message and the progress status that there is a high probability that it is necessary to deal with the failure in another way as well to solve it although brightness is not problematic. Also, the fact that the currently executed mode is a “failure analyzing mode” is displayed.

Once a two-dimensional barcode is displayed on the display device 30, the person who is in charge of support images the two-dimensional barcode by the imaging unit 203 of the terminal device 20.

Once the terminal device 20 images the two-dimensional barcode displayed on the display device 30, the terminal device 20 transmits the imaged two-dimensional barcode to the terminal device 10 (Step S206). The terminal device 20 may transmit the image itself of the two-dimensional barcode to the terminal device 10 or may analyze whether the image is a two-dimensional barcode, extract a code representing an analysis result included in the two-dimensional barcode, and transmit the extracted code to the terminal device 10.

Once the control unit 104 of the terminal device 10 receives the execution result from the terminal device 20, the control unit 104 displays the execution result on the display screen by the output unit 103 (Step S106).

The engineer checks the execution result displayed on the display screen of the terminal device 10 and checks whether or not the failure has been solved. As for the execution result, in a case in which the control command is a command for changing the brightness value to a certain target value, for example, the execution result may be a brightness value after the change or may be a result indicating whether or not the brightness value has been able to be changed normally to the target value.

In a case in which the engineer determines that the dealing with the failure has been completed, the engineer inputs a message including the fact that the dealing with the failure has completed, the reason of the failure, a future dealing method, and the like to the terminal device 10 and presses the transmission button. The terminal device 10 generates a two-dimensional barcode representing the input message and transmits the two-dimensional barcode to the terminal device 20.

Once the terminal device 20 receives the two-dimensional barcode from the terminal device 10, the terminal device 20 displays the received two-dimensional barcode. The person who is in charge of support causes the imaging unit 301 of the display device 30 to image the two-dimensional barcode displayed on the terminal device 20. The display device 30 analyzes the imaged two-dimensional barcode and displays the analysis result on the first display unit 302. In this manner, completion of the dealing with the failure is displayed on the display device 30. The person who is in charge of support can recognize that the dealing with the failure has been completed by checking the display screen.

On the other hand, the engineer performs an operation illustrated in Step S104 in a case in which the engineer determines that the dealing with the failure has not yet been solved. In this manner, the control command for the display, the progress status, and the message are transmitted again from the terminal device 10 to the terminal device 20, such that the display device 30 can be caused to execute the next control command. The engineer can repeat the dealing with the failure in and from Step S104 as needed.

FIG. 15 is a diagram illustrating another example of a display screen displayed on the display device 30 by executing Step S303.

On the display device 30, a two-dimensional barcode (reference sign 1500) indicating the result of executing the control command, a message (reference sign 1501), a progress status (reference sign 1502), and a currently executed mode (reference sign 1503) are displayed. Here, the message includes “analysis ends” and “please end the mode”, which indicates that the analysis of the failure performed by the engineer has been ended and an instruction for ending the failure analyzing mode and returning to an ordinary mode. Also, the progress status is “progress: 100%”, which indicates that the dealing with the failure has been completed. The person who is in charge of support and has viewed the progress status can recognize that the dealing with the failure has been ended.

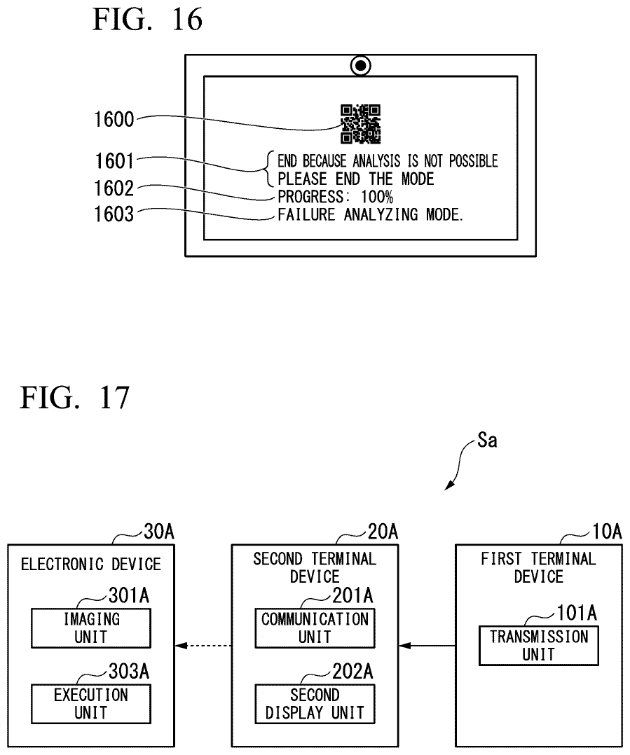

FIG. 16 is a diagram illustrating another example of a display screen displayed on the display device 30 by executing Step S303.

On the display device 30, a two-dimensional barcode (reference sign 1600) indicating a result of executing the control command, a message (reference sign 1601), a progress status (reference sign 1602), and a currently executed mode (reference sign 1603) are displayed. Here, the message includes “end because analysis is not possible” and “please end the mode”, which indicates that the failure has not been able to be remotely dealt with and an instruction for ending the failure analyzing mode and returning to the ordinary mode. Also, the progress status is “progress: 100%”, which indicates that the dealing with the failure has been completed. The person who is in charge of support and has viewed the progress status can recognize that the failure cannot be remotely dealt with and deal with the failure by removing the display device 30 and transporting it to a service center for repairing.

According to the embodiment described above, it is possible to solve a failure from a remote location with a simple configuration using a terminal device such as a smart phone in a case in which the failure occurs in a display at a customer's place or the like.

Note that although the case in which a failure addressing target is the display device 30 has been described in the aforementioned embodiment, the failure addressing target is not limited to the display device and may be an electronic device such as a TV or a projector. In this case, the electronic device may be a device with a camera incorporated therein or a device with a camera optionally attached to the outside thereof.

Also, the failure is not limited to a state where breakdown has occurred in the aforementioned embodiment and may be a case in which the engineer checks whether it is possible to properly perform setting after installation of the display device. In a case in which the display device is newly installed or is installed through model change, a person who is in charge of support or a person who is in charge of installation typically performs setting for brightness, a tone, various modes, and the like. An engineer can remotely check whether or not the content set at this time is correct. It is also possible for the engineer to remotely check whether there are no problems in setting values in a case in which the person who is in charge of installation of the display device has poor knowledge or has little experience in regard to various kinds of setting after the installation.

Also, although the failure may be caused by breakdown, there are also cases where the setting values are not suitable for an installation environment or a utilization environment of the display device. In such a case, the person who is in charge of support may have insufficient knowledge and experience to deal with the failure and may not be able to solve the failure merely by checking and adjusting setting values on the on-screen display (OSD). According to the present embodiment, the failure may be solved by the engineer transmitting a control command from a remote location even in such a case.

Also, according to the aforementioned embodiment, the display device 30 may not have a function of communicably connecting to a network such as the Internet or may have a communication function for performing a near-field wireless communication with the terminal device 20 and the like.

Also, according to the aforementioned embodiment, the display device 30 is caused to image the control command transmitted by the engineer from the terminal device 10 to the terminal device 20, and is caused to execute the control command. In this manner, it is possible to cause the control command to be executed regardless of the display device 30 not having the communication function. Also, if it is attempted to add a communication function to the display device 30, installation of a dedicated application in the display device 30 or connection between a PC connected to the Internet and the display device in which the failure has occurred via a local area network (LAN), RS-232C, or the like is conceivable. However, it becomes necessary to explain a procedure for installing the dedicated application in the PC, a communication connecting method, and the like to the person who is in charge of support, such a way of dealing with the failure is not easy. Large burdens are imposed on both the person who is in charge of support and the engineer. According to the present embodiment, it is possible to cause the display device 30 to image the two-dimensional barcode displayed on the terminal device 20 and to reduce the burdens imposed on the person who is in charge of support and the engineer since it is only necessary to image the two-dimensional barcode displayed on the display device 30 by the terminal device 20.

Also, although it may be difficult for the engineer to visit the place where the display device 30 is installed depending on business matters or the like, it is possible to remotely deal with the failure and to reduce a burden caused for moving.

Note that although the case in which the display device 30 is installed in the customer's place has been described in the aforementioned embodiment, there may be a case in which the display device 30 is removed from the customer's place and is transported to the support center. In this case, using the terminal device 20 and the terminal device 10 allows the engineer to deal with the failure from a location separated from the support center by activating the display device 30 in the support center.

FIG. 17 is a schematic functional block diagram illustrating a configuration of a remote control system Sa according to another embodiment.

The remote control system Sa includes a first terminal device 10A, a second terminal device 20A, and an electronic device 30A.

The first terminal device 10A is used outside a range that can be imaged by the electronic device 30A. The first terminal device 10A includes a transmission unit 101A that transmits control data including a control command for the electronic device 30A.

The second terminal device 20A is used in the range that can be imaged by the electronic device 30A. The second terminal device 20A includes a receiving unit 201A that receives the control data and a second display unit 202A that displays a first image representing the received control data.

The electronic device 30A includes an imaging unit 301A and an execution unit 303A.

The imaging unit 301A captures the first image to be displayed on the second display unit 202A of the second terminal device 20A. Once the first image to be displayed on the second display unit 202A of the second terminal device 20A is captured by the imaging unit 301A, the execution unit 303A extracts the control command from the first image and executes processing based on the control command.

The functions of the terminal device 10, the first terminal device 10A, the terminal device 20, the second terminal device 20A, the display device 30, and the electronic device 30A in the aforementioned embodiment may be realized by computers. In such a case, the functions may be realized by recording a program for realizing the functions in a computer-readable recording medium and causing a computer system to read and execute the program recorded in the recording medium. Note that the “computer system” described here is assumed to include an OS and hardware such as peripheral devices. Also, the “computer-readable recording medium” means a portable medium such as a flexible disk, a magneto-optical disc, a ROM, or a CD-ROM or a storage device such as a hard disk incorporated in the computer system. Furthermore, the “computer-readable recording medium” may include a recording medium that dynamically holds the program for a short period of time, such as a communication line in a case in which the program is transmitted via a network such as the Internet or a communication line such as a telephone line, and a recording medium that holds the program for a specific period of time, such as a volatile memory inside the computer system serving as a server or a client in that case. Also, the above program may be for realizing some of the aforementioned functions, or may be a program that can realize the aforementioned functions in combination with a program that has already been recorded in the computer system, or may be realized using a programmable logic device such as a field programmable gate array (FPGA).

Although the embodiments of the present invention have been described in detail with reference to the drawings, specific configurations are not limited to the embodiments and include designs and the like without departing from the gist of the invention.

### REFERENCE SIGNS LIST

10, 20 Terminal device
10A First terminal device
20A Second terminal device
21, 31 Camera
30 Display device
30A Electronic device
101, 201 Communication unit
101A Transmission unit
102 Input unit
103 Output unit
104, 204, 305 Control unit
210A Receiving unit
202, 202A Second display unit
203, 301, 301A Imaging unit
302 First display unit
303, 303A Execution unit
304 Display control unit

What is claimed is:

1. A remote control system comprising:
an electronic device that comprises an imaging unit;
a first terminal device that is used outside a range that is able to be imaged by the electronic device; and
a second terminal device that is used in the range that is able to be imaged by the electronic device,
wherein the first terminal device comprises:
a transmission unit that transmits control data including a control command for the electronic device,
wherein the second terminal device comprises:
a receiving unit that receives the control data, and
a second display unit that displays a first image representing the received control data, and
wherein the electronic device comprises:
an execution unit that extracts the control command from the first image and executes processing based on the control command once the first image to be displayed on the second display unit is captured by the imaging unit.

2. The remote control system according to claim 1, wherein the first image is an optically readable code.

3. The remote control system according to claim 1,
wherein the electronic device comprises:
a first display unit, and
a display control unit that causes the first display unit to display a second image representing, by an optically readable code, an execution status after the control data is executed,
the second terminal device comprises
an imaging unit that captures the second image displayed by the electronic device, and
a transmission unit that transmits the execution status represented by the second image to the first terminal device, and
the first terminal device comprises
an output unit that outputs the execution status transmitted from the second terminal device.

4. The remote control system according to claim 3,
wherein the display control unit of the electronic device causes the first display unit to display response content in response to a command included in the control data,
the imaging unit of the second terminal device images the response content displayed by the first display unit,
the transmission unit of the second terminal device transmits response content based on a result of the imaging to the first terminal device, and
the output unit of the first terminal device outputs the response content transmitted by the second terminal device.

5. The remote control system according to claim 3, wherein the first terminal device comprises
an input unit that receives an input of a message representing explanation content related to processing that the electronic device is caused to perform,
the transmission unit of the first terminal device transmits the message to the second terminal device,
the receiving unit of the second terminal device receives the message,
the second display unit of the second terminal device displays the first image including the message and the control data, and
the electronic device displays the message included in the first image on the first display unit.

6. The remote control system according to claim 5, wherein the second display unit of the second terminal device displays a character sequence in accordance with the message.

7. A remote control method that is performed by a remote control system comprising:
an electronic device that comprises an imaging unit,
a first terminal device that is used outside a range that is able to be imaged by the electronic device, and
a second terminal device that is used in the range that is able to be imaged by the electronic device,
the method comprising:
transmitting, by the first terminal device, control data including a control command for the electronic device;
receiving, by the second terminal device, the control data; and
displaying a first image representing the received control data on a second display unit; and
imaging, by the electronic device, the first image to be displayed on the second display unit by the imaging unit; and
extracting, by the electronic device, the control command from the imaged first image and executing processing based on the control command.

8. The remote control method according to claim 7, further comprising:
displaying, by the electronic device, a second image representing, by an optically readable code, an execution status after the control data is executed on a first display unit provided in the electronic device;
capturing, by the second terminal device, the second image displayed by the electronic device; and
transmitting the execution status represented by the second image to the first terminal device; and
outputting, by the first terminal device, the execution status transmitted from the second terminal device.
